(19) United States
(12) Patent Application Publication
(10) Pub. No.: US 2021/0082416 A1
(43) Pub. Date: Mar. 18, 2021

(54) GESTURE ANNOTATION FOR WAKING UP A VIRTUAL ASSISTANT

(71) Applicant: GM Global Technology Operations LLC, Detroit, MI (US)

(72) Inventors: Gaurav Talwar, Novi, MI (US); Phani Pavan Kuman Lakkavajhala, Sterling Heights, MI (US); Christopher Oesterling, Troy, MI (US)

(21) Appl. No.: 16/569,125

(22) Filed: Sep. 12, 2019

(51) Int. Cl. G10L 15/22; G06F 3/01

(52) U.S. Cl. CPC G10L 15/22; G06F 3/017; G06F 3/0481; G10L 2015/223; G06F 3/016

(57) ABSTRACT

A method to operate a virtual assistant for a motor vehicle includes one or more of the following: determining if the virtual assistant is dormant; activating the virtual assistant if dormant; and accomplishing an action by the virtual assistant.

### INTRODUCTION

The present disclosure relates to virtual assistants for motor vehicles. More specifically, the present disclosure relates to waking up a virtual assistant for motor vehicles.

Many motor vehicles utilize virtual assistant systems to enable one or more occupants of the motor vehicle to interact with the motor vehicle. When these systems are in a dormant state, an occupant typically wakes the virtual assistant system up with a push to talk button. In some systems, the occupant taps on an existing icon on a screen to wake up the virtual assistant system. In some situations, however, the use of push to talk button or tapping an icon are not practical.

Thus, while current virtual assistant systems achieve their intended purpose, there is a need for a new and improved system and for providing virtual assistance to one or more occupants in a motor vehicle.

### SUMMARY

According to several aspects, a method to operate a virtual assistant for a motor vehicle includes one or more of the following: determining if the virtual assistant is dormant; activating the virtual assistant if dormant; and accomplishing an action by the virtual assistant.

In an additional aspect of the present disclosure, if the virtual assistant is not dormant, interpret an input of an occupant of the motor vehicle.

In another aspect of the present disclosure, the method further includes determining if the action is within a scope of the virtual assistant.

In another aspect of the present disclosure, if the action is within the scope of the virtual assistant, the virtual assistant accomplishes the action.

In another aspect of the present disclosure, if the action is not within the scope of the virtual assistant, the action is ignored.

In another aspect of the present disclosure, activating includes a gesture of an occupant of the motor vehicle.

In another aspect of the present disclosure, activating includes recognition of speech of an occupant of the motor vehicle.

In another aspect of the present disclosure, activating includes a touch by an occupant of the motor vehicle on a haptic screen.

In another aspect of the present disclosure, accomplishing the action includes an interaction with an occupant of the motor vehicle.

According to several aspects, a method to operate a virtual assistant for a motor vehicle includes determining if the virtual assistant is dormant; if the virtual assistant is not dormant, interpret an input of an occupant of the motor vehicle; activating the virtual assistant if dormant; and accomplishing an action by the virtual assistant, such that accomplishing the action includes an interaction with an occupant of the motor vehicle.

In another aspect of the present disclosure, the method further includes determining if the action is within a scope of the virtual assistant.

In another aspect of the present disclosure, if the action is within the scope of the virtual assistant, the virtual assistant accomplishes the action.

In another aspect of the present disclosure, if the action is not within the scope of the virtual assistant, the action is ignored.

In another aspect of the present disclosure, activating includes a gesture of an occupant of the motor vehicle.

In another aspect of the present disclosure, activating includes recognition of speech of an occupant of the motor vehicle.

In another aspect of the present disclosure, activating includes a touch by an occupant of the motor vehicle on a haptic screen.

According to several aspects, a method to operate a virtual assistant for a motor vehicle includes one or more of the following: determining if the virtual assistant is dormant; if the virtual assistant is not dormant, interpreting an input of an occupant of the motor vehicle; activating the virtual assistant if dormant by at least one of a gesture of an occupant of the motor vehicle, recognition of speech of the occupant and a touch by the occupant on a haptic screen; and accomplishing an action by the virtual assistant, such that accomplishing the action includes an interaction with an occupant of the motor vehicle.

In another aspect of the present disclosure, the method further includes determining if the action is within a scope of the virtual assistant.

In another aspect of the present disclosure, if the action is within the scope of the virtual assistant, the virtual assistant accomplishes the action.

In another aspect of the present disclosure, if the action is not within the scope of the virtual assistant, the action is ignored.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic description of a virtual assistant system for a motor vehicle according to an exemplary embodiment;

FIG. 2 is a diagram of a process to operate the virtual assistant according to an exemplary embodiment; and

FIG. 3 is flow diagram of a detailed process to operate the virtual assistant with a touch event according to an exemplary embodiment.

### DETAILED DESCRIPTION

The following description is merely exemplary in nature and is not intended to limit the present disclosure, application, or uses.

Referring to FIG. 1, there is shown a virtual assistant system 10 for a motor vehicle. The virtual assistant system 10 includes an electronic control unit (ECU) 12 that communicates with a plurality of sensors 14, 16 and 18 and an interface, such a screen 20, that enables an occupant in the motor vehicle to communicate with the virtual assistant system 10.

The ECU 12 receives input signals from various the various sensors 14, 16 and 18 configured to generate the signals in proportion to various physical parameters. Furthermore, the ECU 11 may generate output signals to various control devices that are arranged to control the operation of the virtual assistant system 10, including, but not limited to, the plurality of sensors 14, 16 and 18 and the screen 20. Although FIG. 1. shows three sensors 14, 16 and 18, the plurality of sensors includes as few as one sensor or more than three sensors in various arrangements.

In some arrangements, the ECU 12 includes a digital central processing unit (CPU) in communication with a memory system and an interface bus. The CPU is configured to execute instructions stored as a program in the memory system and send and receive signals to/from the interface bus. The memory system may include various non-transitory, computer-readable storage medium including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of the processes described below to control the virtual assistant system 10.

The program stored in ECU 12 is transmitted from outside via a cable or in a wireless fashion. Outside the motor vehicle, it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, for example, an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are, for example, made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 12, the virtual assistant system 10 has, in some arrangements, a different type of processor to provide the electronic logic, for example, an embedded controller, an onboard computer, or any processing module that might be deployed in the vehicle. One of the tasks of the ECU 12 is that of operating the sensors 14, 16 and 18 and the screen 20 to provide an interface between one or more occupants of the motor vehicle and the virtual assistant system 10.

The plurality of sensors 14, 16 and 18, in various arrangements, are one of or a combination of the following: touch or haptic sensors positioned about the cabin of the motor vehicle, interior viewing cameras positioned about the cabin of the motor vehicle and microphones positioned about the cabin. In particular arrangements, the haptic sensors are positioned on the steering wheel of the motor vehicle.

The haptic sensors are sensors that identify a fingerprint of certain occupants that are allowed to interface with the virtual assistant system 10. Additionally or alternatively, the haptic sensors in various arrangements are touch sensors that identify gestures such as a tight squeeze of the steering wheel and/or a touch contact of the steering wheel by the driver of the motor vehicle.

In some arrangements, one or more of the plurality of sensors are cameras that, for example, recognize various gestures from one or more occupants in the motor vehicle. For example, certain movements, such as movements of an occupant's hand provide certain instructions to the virtual assistant system 10. In various arrangements, the one or more cameras identify a driver nodding off or drooling as a sleeping driver such that the virtual assistant system 10 wakes up the driver.

In particular arrangements, one or more of the plurality of sensors 14, 16 and 18 are microphones that receive voice commands from one or more occupants in the motor vehicle. In certain arrangements, the virtual assistant system 10 is trained to receive instructions and voice commands from only certain occupants to accomplish certain tasks.

In various arrangements, the screen 20 is a haptic screen is situated in the dashboard area within the cabin of the motor vehicle and responds to a touch from, for example, the driver of the motor vehicle. In addition to the one or more haptic sensors on the steering wheel, or alternatively, the screen 20 is trained to recognize the fingerprint of an occupant in the motor vehicle.

In various scenarios, the virtual assistant system 10 is activated from a dormant state up by one or more swipes of touches anywhere on the screen 20. The virtual assistant system 10 is trained to recognize the touch pattern to wake up. In some examples, if the occupant simply taps the screen 20 with four fingers, the virtual assistant system 10 activates an audio interface with the occupant. After wakeup, a speech signature is utilized to authenticate access to the voice recognition aspect of the virtual assistant system 10. Alternatively, the screen 20 recognizes a fingerprint of the occupant to allow the occupant to access the virtual assistant system 10. In particular arrangements, the virtual assistant system 10 is trained to recognize touch patterns as YES or NO confirmations. For example, frequent taps to the screen 10 means NO and a single swipe means YES. The virtual assistant system 10 does not necessarily require the use of existing icons on the screen 20.

In particular arrangements, the sensors in the steering wheel senses a particular touch as invoking the virtual assistant system 10 to wake up. In some arrangements, a squeeze of the steering wheel is identified by the virtual assistant system 10 as a health emergent condition or driver frustration of the traffic. As such, the virtual assistant system 10 invokes a traffic assistance application that incorporates current traffic conditions to provide alternative routing scenarios for the motor vehicle. Accordingly, the sensors in the steering wheel identify various taps, such as, double taps, tight squeezes and hard smacks to wake up the virtual assistant system 10 and activate various assistance applications.

In other arrangements, the virtual assistant system 10 utilizes the aforementioned microphones to identify voice commands from one or more occupants to wake up the virtual assistant system 10 and to accomplish requested takes instructed by the one or more occupants. The virtual assistant system 10, in particular arrangements, leverages interior facing cameras to monitor occupant gestures utilizing machine visioning (MV). Some examples include, but are not limited to, an occupant with a raised hand to initiate a virtual voice assistant, a wave to cancel the voice assistant, a nod to confirm YES, and a head shake for NO. In some arrangements, the virtual assistant system 10 only allows certain occupants to command and control the virtual assistant system 10 based on, for example, seat position in the cabin and/or facial recognition.

Any of the aforementioned scenarios and arrangements can be configured with an infotainment radio situated in the motor vehicle or a mobile application.

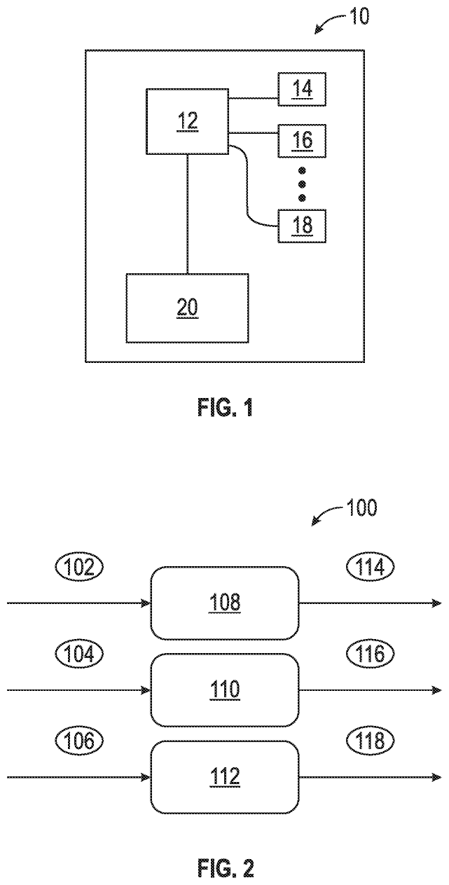

Referring now to FIG. 2, there is shown various touch sequences 100 for one or more occupants in the motor vehicle to wake up and interact with the virtual assistant system 10. For example, a touch pattern 102 is a double tap 108 that activates a speech session with the virtual assistant system 10. In another example, a touch pattern 104 is a tight squeeze of a shaking of the steering wheel to trigger a health monitor of an occupant or frustration with the traffic, such that the virtual assistant system 10 invokes a traffic assistance application that incorporates current traffic conditions to provide optimal alternative routing scenarios for the motor vehicle. In yet another example, a touch pattern 106 is a hard strike to the steering wheel to alert and trigger a response from the virtual assistant system 10 of an emergency situation.

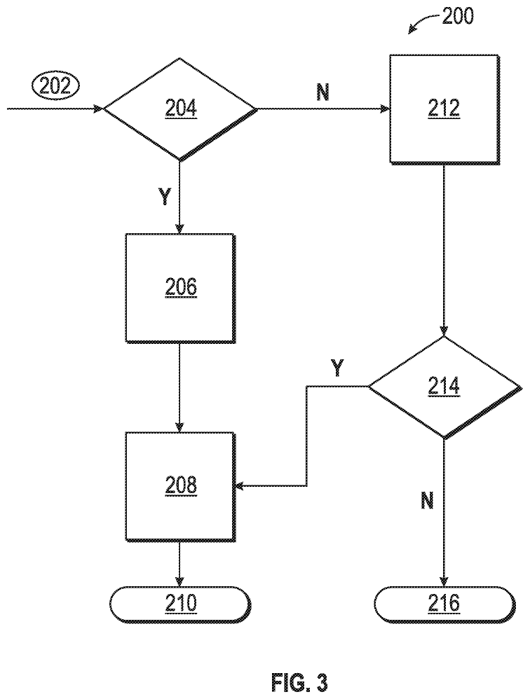

Referring to FIG. 3, there is shown a flow diagram of a process 200 that occurs for a particular touch event 202, such as a touch pattern on the steering wheel of screen 20. In decision step 204, the virtual assistant system 10 determines if the virtual assistant system 10 is dormant. If the virtual assistant system 10 is dormant, the process 200 wakes up the virtual assistant system 10 in step 206. The virtual assistant system 10 then accomplishes the requested action as trained in step 208 to achieve an outcome as desired by the occupant in step 210.

If the virtual assistant system 10 is not dormant, then in step 212, the virtual assistant system 10 interprets that action as it is trained. In decision step 214, the process 200 determines if the action requested is within the scope of the virtual assistant system 10. If the action is not within the scope, the process 200 ignores the requested action in step 216. If the action is within the scope, the process 200 proceeds to step 208 where the virtual assistant system 10 accomplishes the requested action as trained in step 208 to achieve an outcome as desired by the occupant in step 210.

Note that any of the touch events described in relation to FIGS. 2 and 3 can be replaced or utilized in conjunction with voice recognition events and visual events as described previously.

A virtual assistant system of the present disclosure offers several advantages. These include utilization of a multitude of touch patterns, voice commands, visual commands by one or more occupants of a motor vehicle to wake up and interact with the virtual assistant system. The virtual assistant system 10 enables interaction between one or more occupants and the virtual assistant system with the use of convention push to talk buttons

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method to operate a virtual assistant for a motor vehicle, the method comprising:
determining if the virtual assistant is dormant;
activating the virtual assistant if dormant; and
accomplishing an action by the virtual assistant.

2. The method of claim 1, wherein if the virtual assistant is not dormant, interpret an input of an occupant of the motor vehicle.

3. The method of claim 1, further comprising determining if the action is within a scope of the virtual assistant.

4. The method of claim 3, wherein if the action is within the scope of the virtual assistant, the virtual assistant accomplishes the action.

5. The method of claim 3, wherein if the action is not within the scope of the virtual assistant, the action is ignored.

6. The method of claim 1, wherein activating includes a gesture of an occupant of the motor vehicle.

7. The method of claim 1, wherein activating includes recognition of speech of an occupant of the motor vehicle.

8. The method of claim 1, wherein activating includes a touch by an occupant of the motor vehicle on a haptic screen.

9. The method of claim 1, wherein accomplishing the action includes an interaction with an occupant of the motor vehicle.

10. A method to operate a virtual assistant for a motor vehicle, the method comprising:
determining if the virtual assistant is dormant;
if the virtual assistant is not dormant, interpret an input of an occupant of the motor vehicle;
activating the virtual assistant if dormant; and
accomplishing an action by the virtual assistant, wherein accomplishing the action includes an interaction with an occupant of the motor vehicle.

11. The method of claim 10, further comprising determining if the action is within a scope of the virtual assistant.

12. The method of claim 11, wherein if the action is within the scope of the virtual assistant, the virtual assistant accomplishes the action.

13. The method of claim 11, wherein if the action is not within the scope of the virtual assistant, the action is ignored.

14. The method of claim 10, wherein activating includes a gesture of an occupant of the motor vehicle.

15. The method of claim 10, wherein activating includes recognition of speech of an occupant of the motor vehicle.

16. The method of claim 10, wherein activating includes a touch by an occupant of the motor vehicle on a haptic screen.

17. A method to operate a virtual assistant for a motor vehicle, the method comprising:
determining if the virtual assistant is dormant;
if the virtual assistant is not dormant, interpreting an input of an occupant of the motor vehicle;
activating the virtual assistant if dormant, wherein activating includes at least one of a gesture of an occupant of the motor vehicle, recognition of speech of the occupant and a touch by the occupant on a haptic screen; and
accomplishing an action by the virtual assistant, wherein accomplishing the action includes an interaction with an occupant of the motor vehicle.

18. The method of claim 17, further comprising determining if the action is within a scope of the virtual assistant.

19. The method of claim 18, wherein if the action is within the scope of the virtual assistant, the virtual assistant accomplishes the action.

20. The method of claim 18, wherein if the action is not within the scope of the virtual assistant, the action is ignored.
